(19) United States
(12) Patent Application Publication
(10) Pub. No.: US 2014/0285443 A1
(43) Pub. Date: Sep. 25, 2014

(54) METHOD AND SYSTEM FOR KEYGLOVE FINGERMAPPING AN INPUT DEVICE OF A COMPUTING DEVICE

(71) Applicant: Unisys Corporation, (US)

(72) Inventor: Kenneth R. D'Souza, Bangalore (IN)

(73) Assignee: Unisys Corporation, Blue Bell, PA (US)

(21) Appl. No.: 13/847,081

(22) Filed: Mar. 19, 2013

(51) Int. Cl. G06F 3/01; G06F 3/041

(52) U.S. Cl. CPC G06F 3/014; G06F 3/041
USPC 345/173

(57) ABSTRACT

An input device and system for a computing device. The input device includes a plurality of touch-sensitive registration elements for positioning at various locations of at least one finger of at least one hand of a user of the computing device. The plurality of registration elements are configured to be coupled to a processor of the computing device. Also, the plurality of registration elements are configured to provide, in response to being touched by the user, a signal to the processor of the computing device indicative of the location of the touch-sensitive registration element.

### BACKGROUND

1. Field

The instant disclosure relates generally to input devices of computing devices, and more particularly, to fingermapping an input device of a computing device.

2. Description of the Related Art

In the use of computing devices, one common input device is the standard keyboard, which has alpha, numeric and special characters. Typically, the structure of a standard keyboard input device for a computing device is rectangular and generally has a relatively flat shape. Typically, a standard keyboard input device is external to the corresponding computing device and connected to the central processing unit of the corresponding computing device either by a wire or wirelessly via Bluetooth, Infrared technology or other suitable wireless means.

In such conventional input devices, the layout of the input device typically is relatively flat, thus requiring a certain amount physical space where the computer is installed situated. Also, moving such an external input device typically requires a conscious effort.

Alternatively, some computing devices, such as mobile phones and personal digital assistants (PDAs), have an input device embedded therein or thereon. Such computing devices typically have a keypad or keyboard input device as coherent part of the computing device itself. In such computing devices, there is no exterior wire connected from the keypad or keyboard input device to the central processing unit of the computing device. The keypad or keyboard input device typically is on the exterior surface of the computing device or within the interior of the computing device via a touchscreen or other suitable touch-enabled mechanisms.

### SUMMARY

Disclosed is an input device and system for a computing device, The input device includes a plurality of touch-sensitive registration elements for positioning at various locations of at least one finger of at least one hand of a user of the computing device, The plurality of registration elements are configured to be coupled to a processor of the computing device. Also, the plurality of registration elements are configured to provide, in response to being touched by the user, a signal to the processor of the computing device indicative of the location of the touch-sensitive registration element.

### BRIEF DESCRIPTION OF THE DRAWINGS

FIG. 1 is a schematic view of a plurality of registration elements for fingermapping an input device of a computing device, according to an embodiment;

FIG. 2 is a schematic view of a plurality of registration elements positioned at various user fingerline positions, according to an embodiment;

FIG. 3 is a schematic view of an apparatus for fingermapping an input device of a computing device, according to an embodiment;

FIG. 4 is a schematic view of an apparatus for fingermapping an input device of a computing device positioned on the hands of a user, according to an embodiment;

FIG. 5 is a schematic view of a set of input device character representations for a plurality of registration elements positioned at various user fingerline positions, according to an embodiment;

FIG. 6 is a schematic view of an alternative set of input device character representations for a plurality of registration elements positioned at various user fingerline positions, according to an embodiment;

FIG. 7 is a flow diagram of a method for fingermapping an input device of a computing device, according to an embodiment; and

FIG. 8 is a schematic diagram of a system for fingermapping an input device of a computing device, according to an embodiment.

### DETAILED DESCRIPTION

In the following description, like reference numerals indicate like components to enhance the understanding of the disclosed method and apparatus for providing low latency communication/synchronization between parallel processes through the description of the drawings. Also, although specific features, configurations and arrangements are discussed hereinbelow, it should be understood that such is done for illustrative purposes only. A person skilled in the relevant art will recognize that other steps, configurations and arrangements are useful without departing from the spirit and scope of the disclosure.

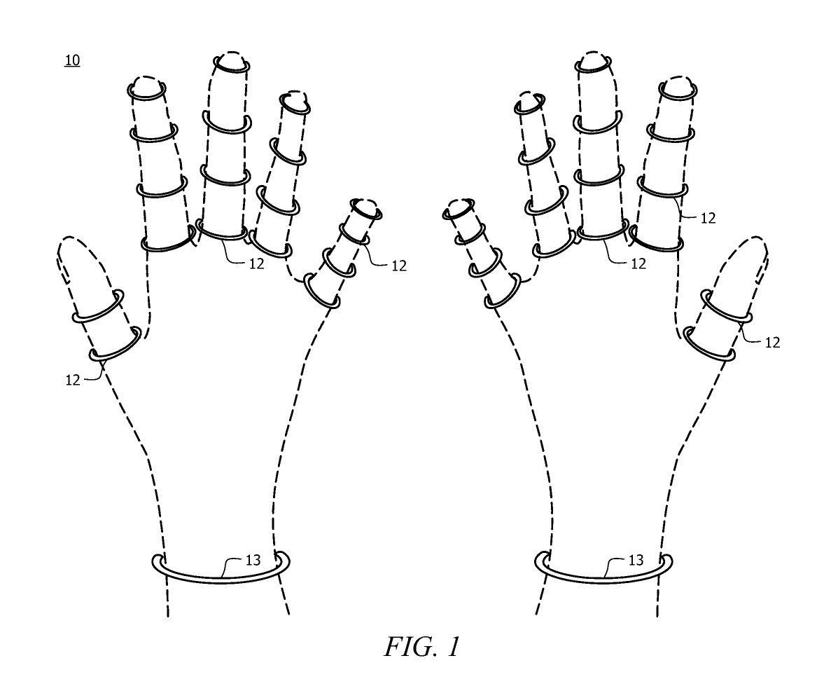

FIG. 1 is a schematic view 10 of a plurality of registration elements 12 for fingermapping an input device of a computing device, according to an embodiment. The registration elements 12 are configured in the form of a plurality of touch-sensitive holders, rings or other suitable components that can be coupled to, positioned on or positioned around various fingerline positions, e.g., at the various joints of the thumb and fingers and also on the tips of one or more of the fingers. Also, as will be discussed in greater detail hereinbelow, a bangle 13 can be configured to be positioned around the wrist of each hand.

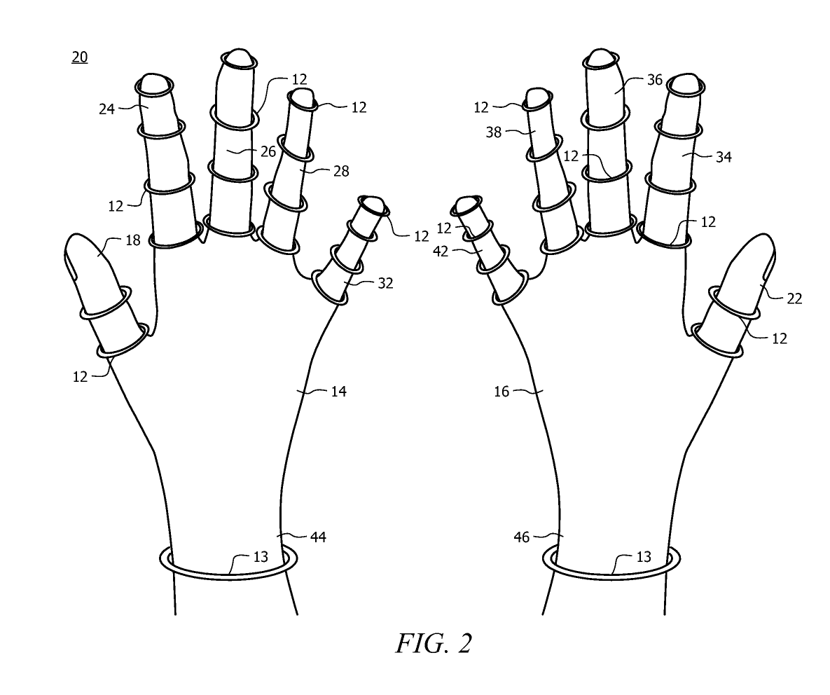

FIG. 2 is a schematic view 20 of the plurality of registration elements 12 positioned at various user fingerline positions according to an embodiment. For example, registration elements 12 can be positioned on the thumb and fingers of a left hand 14 of a user and the thumb and fingers of a right hand 16 of the user, e.g., at the various joints of the fingers and on the tips of one or more of the fingers,

For example, two registration elements 12 can be configured to be positioned at or near each joint location of a thumb 18 of the left hand 14 and two registration elements 12 can be configured to be positioned at or near each joint location of a thumb 22 of the right hand 16. Also, four registration elements 12 can be configured to be positioned at or near the tip and at or near each joint location of an index finger 24, a middle finger 26, a ring finger 28 and a pinky finger 32 of the left hand 14. Similarly, four registration elements 12 can be configured to be positioned at or near the tip and at or near each joint location of an index finger 34, a middle finger 36, a ring finger 38 and a pinky finger 42 of the right hand 16. Also, a bangle 13 can be configured to be positioned around each of the wrist 44 of the left hand 14 and the wrist 46 of the right hand 16.

Making the use of a suitable method and system for mapping a standard keyboard or other input device of a computing device, an input device for a computing device can exist in the form of the plurality of registration elements 12 for performing the functions of the input device of the computing device. For example, a glove having the registration elements (i.e., a keyglove) can perform the functions of an input device of a computing device. Such glove or other apparatus involves performing input instructions and functions without the use of a conventional computing device keyboard or keypad input device.

Because the basic requirement of a keyboard or keypad input device is to input characters into a corresponding computing device, the input devices described herein typically use a suitable number of registration elements, e.g., 36 registration elements, by which characters, instructions and functions can be generated. Such arrangement or configuration allows the input device to maintain the most features of a standard keyboard or keypad input device.

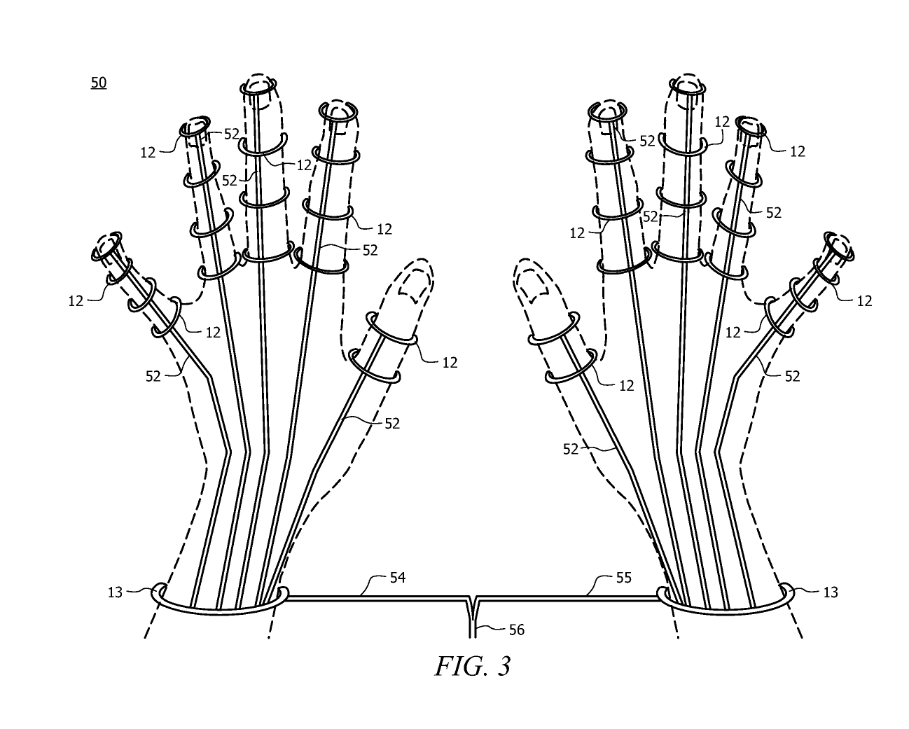

FIG. 3 is a schematic view 50 of an apparatus for fingermapping an input device of a computing device, according to an embodiment. As discussed hereinabove, each finger typically has its own designated set of holders or registration elements 12. Each holder or registration element 12 is touch-sensitive and capable of carrying electronic signals. The electronic signals are signals that correspond to various characters assigned as implemented according to a suitable character mapping method and system,

The holders or registration elements 12 can be connected by one or more wires 52 that terminate at a base, molded in the form of a bangle 13 or other suitable component. Wires 54, 55 from the bangle 13 for each of the left hand 14 and the right hand 16 hand can be coupled together as a single wire 56 and coupled to a central processing unit of the computing device in a suitable manner. Alternatively, the input device apparatus can communicate with the central processing unit of the computing device without wires, e.g., via the use of Bluetooth or other wireless technology, such as shown generally in FIG. 1 and FIG. 2. The method or processing algorithm to generate the appropriate characters can be performed according to a suitable character mapping method and system. For example, see U.S. nonprovisional patent application entitled “METHOD AND SYSTEM FOR FINGERLINE (PHALANGE) MAPPING TO AN INPUT DEVICE OF A COMPUTING DEVICE” filed on _______, 2012, and assigned application Ser. No. __/____.

To position the input device apparatus for use, a user of the computing device wears one bangle 13 around the wrist 44 of the left hand 14 and the other bangle 13 around the wrist 46 of the right hand 16. The user also positions the appropriate set of registration elements 12 on the appropriate fingers (or thumb) of the left hand and the right hand, e.g., by inserting the appropriate finger (or thumb) through the corresponding set of registration elements in such a way that the registration elements are positioned at or near the tips and the joints of the fingers and at or near the joints of the thumbs of the hands of the user.

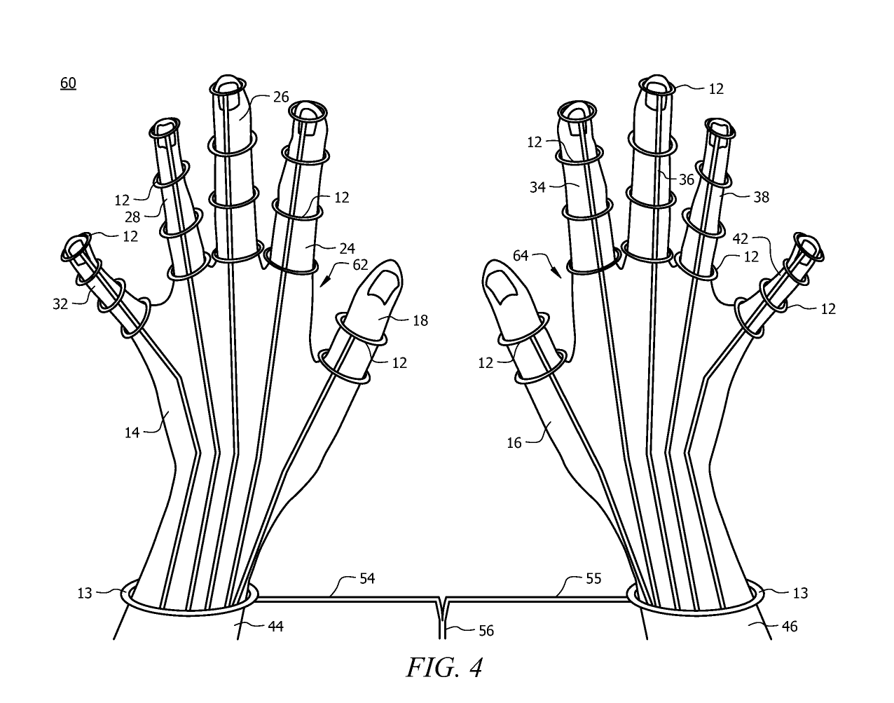

Alternatively, the input device apparatus can be encased or otherwise configured in the form of a glove, i.e., a keyglove. FIG. 4 is a schematic view 60 of a keyglove input device apparatus for fingermapping an input device of a computing device positioned on the hands of a user, according to an embodiment. A glove or keyglove 62 for the left hand 14 of the user and a glove or keyglove 64 for the right hand 16 of the user can be made up of any suitable glove material that is resistant to electric signals being conducted through the wires 52 and resistant to any deterioration arising from the touch-sensitive holders or registration elements 12.

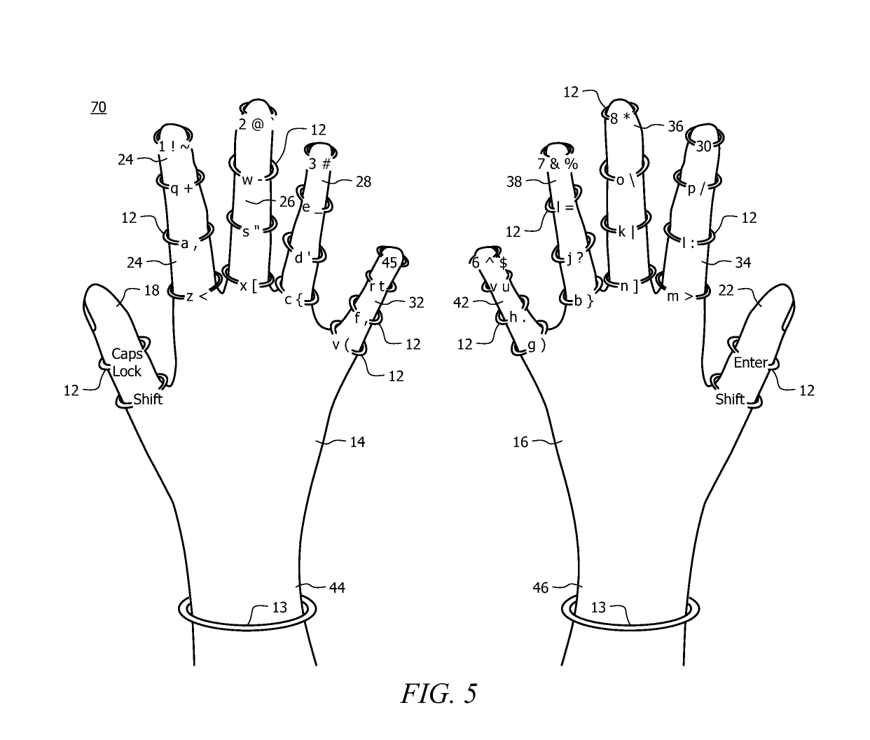

FIG. 5 is a schematic view 70 of a set of input device character representations for the locations of the plurality of registration elements shown in the previous figures. In this particular set of input device character representations, a QWERTY keyboard input device is taken as a reference for mapping. It should be understood that other keyboard, keypad and other input device layouts can be used for mapping.

In this particular character representation, character digits generally correspond to the tips of the fingers in the manner they occur on a standard QWERTY keyboard, with a few minor exceptions, as shown. The other (non-digit) characters generally correspond to the finger lines in the manner they occur on a standard QWERTY keyboard, with a few minor exceptions. Also, the special characters above the numerals in the QWERTY keyboard layout are mapped so that they generally correspond to the same relative positions as they occur in the QWERTY keyboard layout, with a few minor exceptions.

Therefore, in this particular character representation scheme, the fingerline representations have a symmetric pattern of alpha and numeric characters at their respective positions between the left hand 14 and the right hand 16. Moreover, the special characters of opposite characteristics are placed together for the ease of remembrance.

As shown, the tip of the thumb 18 of the left hand 14 and the tip of the thumb 22 of the right hand 16 are not associated with any alpha, number or special characters because, as discussed hereinbelow, the tips of the thumbs are used to touch the particular registration elements 12 to input or register associated characters with the processor of the computing device.

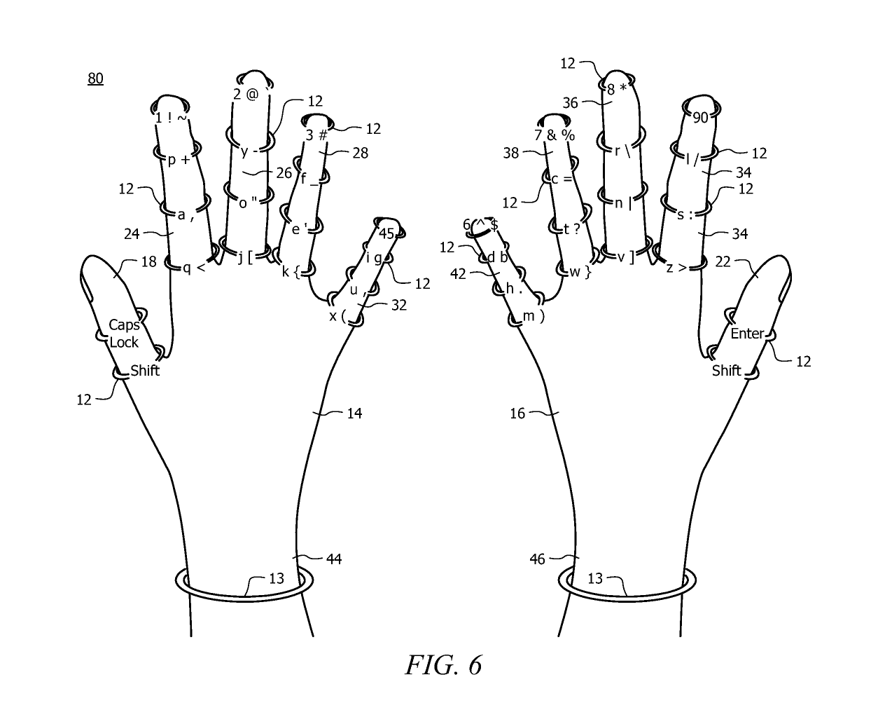

FIG. 6 is a schematic view 80 of an alternative set of input device character representations for the plurality of registration elements shown in the previous figures. In this particular set of input device character representations, a DVORAK keyboard input device is taken as a reference for mapping.

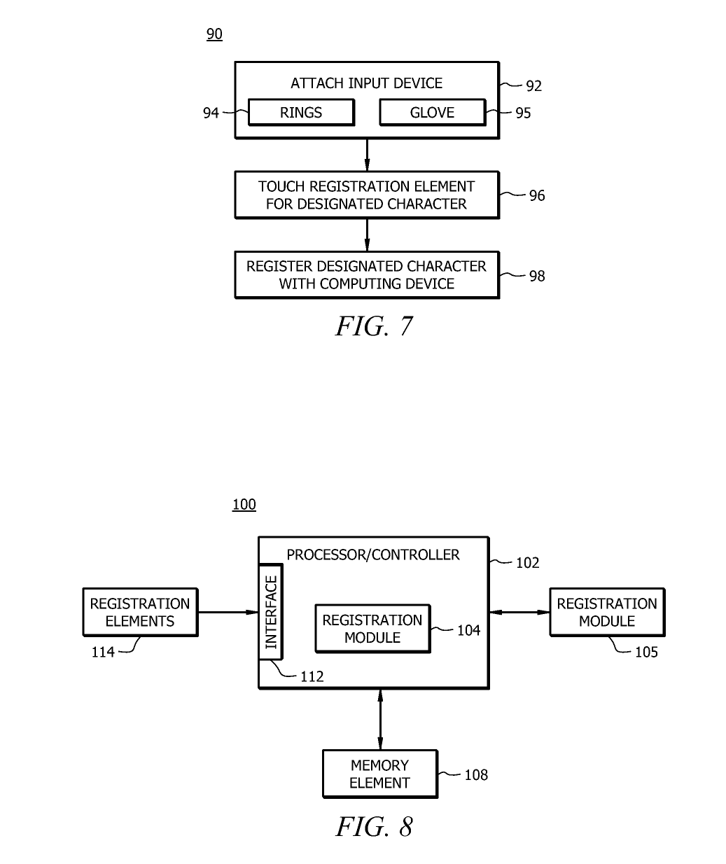

FIG. 7 is a flow diagram of a method 90 for fingermapping an input device of a computing device, according to an embodiment. The method 90 includes a step 92 of coupling, attaching or otherwise positioning the input device apparatus on the left and right hands of a user. As discussed hereinabove, for an input device apparatus having a plurality of registration element rings (shown generally as rings 94), each set of rings is positioned around the corresponding thumb and fingers of each hand of the user. For an input device apparatus in the form of a glove having sets of registration elements affixed or attached thereto (shown generally as 95), the user positions the left hand glove portion over the left hand and positions the right hand glove portion over the right hand in such a way that the registrations elements are positioned at or near the appropriate fingerline positions of the user's thumbs and fingers.

The method 90 also includes a step 96 of touching a registration element for a particular designated character. To use the input device apparatus, the user touches the appropriate registration element 12 corresponding to the designated character with the tip of thumb of the appropriate hand. For various registration elements 12, the tip of the thumb of the same hand can be used to touch the particular registration element 12. For other registration elements 12, and for special characters involving the registration elements 12 associated with the “Shift” and “Caps Lock” characters, the tip of the thumb of the other hand can be used to touch the appropriate registration element 12 associated with the designated character.

More specifically, to select a designated character, the tip of the thumb of the appropriate hand touches the registration element 12 associated with the designated character. To select the second character associated with a particular registration element 12, the tip of the thumb of the appropriate hand touches the designated registration element 12 associated with the designated character, along with the tip of the thumb of the other hand touching the registration element 12 associated with the “Shift” registration element 12.

For example, using the mapping representation shown in FIG. 5, to select a designated character “r,” the tip of the thumb 18 of the left hand 14 or the tip of the thumb 22 of the right hand 16 touches the registration element 12 associated with the “r” character. To select a designated character “t,” the tip of the thumb 18 of the left hand 14 touches the registration element 12 associated with the “t” character, along with the tip of any finger of the right hand 16 touching the registration element 12 associated with the “Shift” character positioned on the thumb 22 of the right hand 16. Alternatively, the tip of the thumb of one hand can be used to point to or contact the “Shift” fingerline position of the other hand, if convenient.

The method 90 also includes a step 98 of registering the designated character with the processor of the computing device. As discussed hereinabove, the registration elements 12 are coupled to a central processing unit of the computing device, and the central processing unit of the computing device includes an appropriate method, process or algorithm to generate and register the appropriate character mapped to or associated with a given registration element 12. When a particular registration element 12 is touched, e.g., by the tip of a thumb of the user, in response to the touching of the registration element 12, the mapped character corresponding to or associated with the touched registration element 12 is registered in the computing device.

FIG. 8 is a schematic diagram of a system 100 for fingermapping an input device of a computing device, according to an embodiment. The system 100 can be any apparatus, device or computing environment suitable for providing fingermapping an input device of a computing device according to an embodiment. For example, the system 100 can be or be contained within any suitable computer system, including a mainframe computer and/or a general or special purpose computer.

The system 100 includes one or more general purpose (host) controllers or processors 102 that, in general, processes instructions, data and other information received by the system 100. The processor 102 also manages the movement of various instructional or informational flows between various components within the system 100. The processor 102 can include a registration module 104 that is configured to execute and perform the fingermapping of an input device of a computing device processes described herein. Alternatively, the system 100 can include a standalone registration module 105 coupled to the processor 102.

The system 100 also can include a memory element or content storage element 106, coupled to the processor 102, for storing instructions, data and other information received and/or created by the system 100. In addition to the memory element 108, the system 100 can include at least one type of memory or memory unit (nor shown) within the processor 102 for storing processing instructions and/or information received and/or created by the system 100,

The system 100 also can include one or more interfaces 112 for receiving instructions, imagery, data and other information from the registration elements 12 (shown collectively as registration elements 114). It should be understood that the interface 112 can be a single input/output interface, or the system 100 can include separate input and output interfaces.

One or more of the processor 102, the registration module 104, the registration module 105, the memory element 108 and the interface 112 can be comprised partially or completely of any suitable structure or arrangement, e.g., one or more integrated circuits. Also, it should be understood that the system 100 includes other components, hardware and software (not shown) that are used for the operation of other features and functions of the system 100 not specifically described herein.

The system 100 can be partially or completely configured in the form of hardware circuitry and/or other hardware components within a larger device or group of components. Alternatively, the processes performed by the system 100 can be partially or completely configured in the form of software, e.g., as processing instructions and/or one or more sets of logic or computer code. In such configuration, the logic or processing instructions typically are stored in a data storage device, e.g., the memory element 108 or other suitable data storage device (not shown). The data storage device typically is coupled to a processor or controller, e.g., the processor 102. The processor accesses the necessary instructions from the data storage element and executes the instructions or transfers the instructions to the appropriate location within the system 100.

One or more of the registration module 104 and the registration module 105 can be implemented in software, hardware, firmware, or any combination thereof. In certain embodiments, the module(s) may be implemented in software or firmware that is stored in a memory and/or associated components and that are executed by the processor 102, or any other processor(s) or suitable instruction execution system. In software or firmware embodiments, the logic may be written in any suitable computer language. One of ordinary skill in the art will appreciate that any process or method descriptions associated with the operation of the registration module 104 and the registration module 105 may represent modules, segments, logic or portions of code which include one or more executable instructions for implementing logical functions or steps in the process. It should be further appreciated that any logical functions may be executed out of order from that described, including substantially concurrently or in reverse order, depending on the functionality involved, as would be understood by those reasonably skilled in the art. Furthermore, the modules may be embodied in any non transitory computer readable medium for use by or in connection with an instruction execution system, apparatus, or device, such as a computer-based system, processor-containing system, or other system that can fetch the instructions from the instruction execution system, apparatus, or device and execute the instructions.

One or more of the controller and processor can be comprised partially or completely of any suitable structure or arrangement, e.g., one or more integrated circuits. Also, it should be understood that the computing device shown include other components, hardware and software (not shown) that are used for the operation of other features and functions of the computing devices not specifically described herein.

The functions described herein may be implemented in hardware, software, firmware, or any combination thereof. If implemented in software, the functions may be stored on or transmitted as one or more instructions or code on a non-transitory computer-readable medium. The methods illustrated in the figures may be implemented in a general, multi-purpose or single purpose processor. Such a processor will execute instructions, either at the assembly, compiled or machine-level, to perform that process. Those instructions can be written by one of ordinary skill in the art following the description of the figures and stored or transmitted on a non-transitory computer readable medium. The instructions may also be created using source code or any other known computer-aided design tool. A non-transitory computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), and the like.

It will be apparent to those skilled in the art that many changes and substitutions can be made to the embodiments described herein without departing from the spirit and scope of the disclosure as defined by the appended claims and their full scope of equivalents.

1. An input device for a computing device, comprising:
a plurality of touch-sensitive registration elements for positioning at various locations of at least one finger of at least one hand of a user of the computing device,
wherein the plurality of registration elements are configured to be coupled to a processor of the computing device, and
wherein the plurality of registration elements are configured to provide, in response to being touched by the user, a signal to the processor of the computing device indicative of the location of the touch-sensitive registration element.

2. The device as recited in claim 1, wherein the plurality of registration elements are mapped to input characters of the computing device, and wherein the plurality of registration elements are configured to provide, in response to being touched by the user, a signal to the processor of the computing device corresponding to the character mapped to the registration element.

3. The device as recited in claim 1, wherein the plurality of registration elements includes a plurality of rings configured to be positioned around various locations of at least one finger of at least one hand of a user, and wherein at least a portion of the plurality of rings are configured to be operably coupled to the processor of the computing device.

4. The device as recited in claim 1, further comprising at least one glove configured to have the plurality of registration elements coupled thereto.

5. The device as recited in claim 1, wherein the plurality of registration elements includes registration elements positioned on a plurality of positions of at least one finger of at least one hand of a user, wherein at least one a portion of the plurality of registration elements are configured to be operably coupled to the processor of computing device.

6. The device as recited in claim 1, wherein the plurality of registration elements includes at least one registration element positioned on at least one position of a plurality of fingers of at least one hand of a user.

7. The device as recited in claim 1, wherein the plurality of registration elements are positioned at various locations of at least one finger of at least one hand in such a way that each of the plurality of registration elements can be touched by the tip of a thumb of a user.

8. The device as recited in claim 1, wherein the plurality of registration elements includes two registration elements for each thumb of each hand of a user and four registration elements for each finger of each hand of a user.

9. The device as recited in claim 8, wherein the two registration elements for each thumb are coupled together and the four registration elements for each finger are coupled together.

10. The device as recited in claim 1, wherein the plurality of registration elements are coupled to the processor of the computing device via a wire or wirelessly.

11. A system for mapping characters of an input device of a computing device, the system comprising:
a plurality of touch-sensitive registration elements for positioning at various locations of at least one finger of at least one hand of a user; and
a processor having a registration module coupled to the plurality of ouch- sensitive registration elements, wherein the processor includes a mapping of characters and functions of the input device of the computing device corresponding to the plurality of touch-sensitive registration elements,
wherein the plurality of registration elements are configured to provide, in response to being touched, a signal to the processor indicative of the location of the touch-sensitive registration element and the corresponding mapped character or function, and
wherein the processor is configured to register a character corresponding to the touched registration element.

12. The system as recited in claim 11, wherein the plurality of registration elements includes a plurality of rings configured to be positioned around various locations of at least one finger of at least one hand of a user, and wherein at least a portion of the plurality of rings are configured to be operably coupled to the processor of the computing device.

13. The system as recited in claim 11, further comprising at least one glove configured to have the plurality of registration elements coupled thereto.

14. The system as recited in claim 11, wherein the plurality of registration elements includes registration elements positioned on a plurality of positions of at least one finger of at least one hand of a user, wherein at least one a portion of the plurality of registration elements are configured to be operably coupled to the processor of the computing device.

15. The system as recited in claim 11, wherein the plurality of registration elements includes at least one registration element positioned on at least one position of a plurality of fingers of at least one hand of a user.

16. The system as recited in claim 11, wherein the plurality of registration elements are positioned at various locations of at least one finger of at least one hand in such a way that each of the plurality of registration elements can be touched by the tip of a thumb of a user.

17. The system as recited in claim 11, wherein the plurality of registration elements includes two registration elements for each thumb of each hand of a user and four registration elements for each finger of each hand of a user.

18. The system as recited in claim 17, wherein the two registration elements for each thumb are coupled together and the four registration elements for each finger are coupled together.

19. The system as recited in claim 11, wherein the plurality of registration elements are coupled to the processor of the computing device via a wire or wirelessly.
